(19) United States
(12) Patent Application Publication
(10) Pub. No.: US 2023/0309463 A1
(43) Pub. Date: Oct. 5, 2023

(54) SUPPORT FOR A CLIMBING PLANT

(71) Applicant: GREY&CO PTE. LTD., Singapore (SG)

(72) Inventor: Junyang CHEN, Singapore (SG)

(73) Assignee: GREY&CO PTE. LTD., Singapore (SG)

(21) Appl. No.: 17/725,130

(22) Filed: Apr. 20, 2022

(30) Foreign Application Priority Data
Mar. 29, 2022 (SG) 10202203201W

(51) Int. Cl. A01G 9/12

(52) U.S. Cl. CPC A01G 9/12

(57) ABSTRACT

A support for a climbing plant, the support comprising: a tubular structure defining a volume for containing therein a substrate, the tubular structure having a plurality of root-passage holes for passage therethrough of roots of the climbing plant to engage the substrate, wherein the tubular structure comprises a single sheet of plastic material having a first long edge, a second long edge, and two short edges; the sheet having the plurality of root-passage holes provided therethrough; the sheet having an integral plurality of tabs extending from the first long edge and spaced apart from each other at intervals along the first long edge; the sheet having a corresponding plurality of tab-engagement holes provided adjacent the second long edge and spaced apart from each other at intervals along the second long edge, wherein the plurality of tabs and the corresponding plurality of tab-engagement holes are in engagement with each other such that the sheet is assembled into the tubular structure.

### CROSS-REFERENCE TO RELATED APPLICATIONS

This application claims priority to and the benefits of Singapore Patent Application No. 10202203201W with a filing date of Mar. 29, 2022, the content of which is incorporated in its entirety herein.

### TECHNICAL FIELD

This invention relates to a support for a climbing plant.

### BACKGROUND

Supports for climbing plants try to mimic the branches of trees that, in the wild, such climbing plants would attach their roots to as they grow upwards. Existing supports such as moss poles may comprise a length of wire mesh that is rolled up and tied to form a tube with a circular cross-section, or may comprise a longitudinal section of a cylinder made of a sheet of plastic material and tied together with a length of wire mesh to define a tube having a generally semi-circular cross-section, for example. Such tubes are then filled with a substrate that roots of the climbing plant will grow into by passing through the holes of the wire mesh into the substrate.

However, making such supports is labour intensive as they require the parts to be aligned, tied together, and trimmed, and can also lead to buckling when the parts are not properly aligned. Furthermore, tying a length of wire mesh to a sheet of plastic material typically requires the ties used (which may be zip or wire ties, for example) to pass through holes made in the sheet of plastic material. This gives rise to stress points at the holes in the plastic material that may cause the ties to tear out through the sheet when the tube is stressed by root growth in the substrate within the tube. In addition, such supports are ecologically unfriendly as they are difficult to disassemble, sort and recycle.

It is therefore desirable to provide a support for a climbing plant that avoids the above disadvantages.

### SUMMARY

This application discloses a support for a climbing plant that comprises only a single part that is easy to assemble into a structure for containing a substrate therein for roots to take hold of and for providing mechanical support for the plant as it grows upwards. The support is preferably made of a single recyclable material that is both easy to assemble and disassemble.

According to a first aspect, there is provided a support for a climbing plant, the support comprising: a tubular structure defining a volume for containing therein a substrate, the tubular structure having a plurality of root-passage holes for passage therethrough of roots of the climbing plant to engage the substrate, wherein the tubular structure comprises a single sheet of plastic material having a first long edge, a second long edge, and two short edges; the sheet having the plurality of root-passage holes provided therethrough; the sheet having an integral plurality of tabs extending from the first long edge and spaced apart from each other at intervals along the first long edge; the sheet having a corresponding plurality of tab-engagement holes provided adjacent the second long edge and spaced apart from each other at intervals along the second long edge, wherein the plurality of tabs and the corresponding plurality of tab-engagement holes are in engagement with each other such that the sheet is assembled into the tubular structure.

Multiple units of the support may be joinable by insertion of a lower end of one unit of the support into an upper end of another unit of the support to create an extended support of increased length.

The support may include a first interlocking structure located adjacent the lower end of the support and a second interlocking structure located adjacent the upper end of the support, wherein the first and second interlocking structures are longitudinally aligned in parallel with the first long edge of the sheet, wherein when the first and second units of the support are joined to create the extended support of increased length, the first interlocking structure of the first unit of the support engages the second interlocking structure of the second unit of the support to prevent separation of the first unit of the support from the second unit of the support.

The first and second interlocking structures may each comprise an embossing made in the sheet.

Alternatively, the first and second interlocking structures may each comprise a flap defined by a U-shaped cut made in the sheet wherein legs of the U-shaped cut are parallel with the first and second short edges, wherein when the first and second units of the support are joined to create the extended support, the first U-shaped cut of the first unit of the support is congruent with the second U-shaped cut of the second unit, such that bending the flaps together in a same direction away from a surface of the extended support prevents separation of the first unit of the support from the second unit of the support.

The support may further comprise at least one anchor tab provided adjacent the first short edge for engaging a growing medium in which the support is embedded to anchor the support in the growing medium, the anchor tab comprising an upward facing and outwardly extending tab assembled from a further U-shaped cut made in the sheet wherein legs of the further U-shaped cut point towards the first short edge.

According to a second aspect, there is provided a blank for forming a support for a climbing plant, the blank comprising: a single sheet of plastic material having a first long edge, a second long edge, and two short edges; the sheet having a plurality of root-passage holes for passage therethrough of roots of the climbing plant; the sheet having an integral plurality of tabs extending from the first long edge and spaced apart from each other at intervals along the first long edge; the sheet having a corresponding plurality of tab-engagement holes provided adjacent the second long edge and spaced apart from each other at intervals along the second long edge, wherein the plurality of tabs and the corresponding plurality of tab-engagement holes are configured to engage each other for assembling the sheet into a tubular structure to form the support.

The blank may include a first interlocking structure located adjacent the first short edge and a second interlocking structure located adjacent the second short edge, wherein the first and second interlocking structures are longitudinally aligned in parallel with the first long edge of the sheet, such that when a first unit of the blank and a second unit of the blank are each assembled to form a respective first unit of the support and second support unit of the support, and when the first and second units of the support are joined by insertion of a lower end of the first unit the support into an upper end of the second unit of the support to create an extended support of increased length, the first interlocking structure engages the second interlocking structure to prevent separation of the first unit of the support from the second unit of the support.

The first and second interlocking structures may each comprise an embossing made in the sheet.

Alternatively, the first and second interlocking structures may each comprise a flap defined by a U-shaped cut made in the sheet wherein legs of the U-shaped cut are parallel with the first and second short edges, when the first and second units of the support are joined to create the extended support, the first U-shaped cut of the first unit of the support is congruent with the second U-shaped cut of the second unit, such that bending the flaps together in a same direction away from a surface of the extended support prevents separation of the first unit of the support from the second unit of the support.

The blank may include an anchor tab defined by a further U-shaped cut made in the sheet adjacent the first short edge, wherein legs of the further U-shaped cut-out point towards the first short edge.

For both aspects, the sheet may comprise a first longitudinal portion comprising the first long edge, a second longitudinal portion comprising the second long edge, and a central longitudinal portion provided between the first and second longitudinal portion, wherein the plurality of root-passage holes are provided on at least the central longitudinal portion.

The sheet may comprise a first longitudinal score line provided to facilitate bending without breaking of the sheet between the first longitudinal portion and the central longitudinal portion, wherein the sheet comprises a second longitudinal score line provided to facilitate bending without breaking of the sheet between the second longitudinal portion and the central longitudinal portion, and wherein bending of the sheet along both the first and second longitudinal score lines facilitates meeting and engagement of the plurality of tabs with the plurality of tab-engagement holes.

Each of the plurality of tabs may comprise a tab head and a tab neck connecting the tab head to the first long edge, wherein the tab head is configured to be manipulated through a corresponding one of the plurality of tab-engagement holes and to prevent slipping of the tab head back out of the tab-engagement hole, and wherein the tab neck has a width able to be accommodated by the tab-engagement hole.

Each of the plurality of tab-engagement holes may comprise a slit provided through the sheet, wherein each tab head has a free end and a necked end adjoining the tab neck, wherein the free end has a width less than the length of the slit, and wherein the necked end has a width greater than a length of the slit.

The tab head may have a shape that is one of: a triangle, a semi-circle, and an isosceles trapezoid.

The plurality of root-passage holes may be arranged in a grid configuration through the sheet.

The plastic material may comprise polyethylene terephthalate.

### BRIEF DESCRIPTION OF DRAWINGS

In order that the invention may be fully understood and readily put into practical effect there shall now be described by way of non-limitative example only exemplary embodiments of the present invention, the description being with reference to the accompanying illustrative drawings, in which:

FIG. 1 is a perspective view of a first exemplary embodiment of a support for a climbing plant.

FIG. 2 is a front view of the support of FIG. 1.

FIG. 3 is a back view of the support of FIG. 1.

FIG. 4 is a side view of the support of FIG. 1.

FIG. 5 is a top view of the support of FIG. 1.

FIG. 6 is a close-up front perspective view of a top interior part of the support of FIG. 1.

FIG. 7 is a perspective view of the support of FIG. 1 in use supporting a climbing plant thereon.

FIG. 8 is a front view of an exemplary embodiment of a blank for forming the support of FIG. 1.

FIG. 9 is a front view of a first alternative embodiment of the blank of FIG. 8.

FIG. 10 is a front view of a second alternative embodiment of the blank of FIG. 8.

FIG. 11 is a schematic illustration of force distribution on a triangle.

FIG. 12 is a schematic illustration of a semi-circular cross-section providing continuously variable triangles of support.

### DETAILED DESCRIPTION OF THE EMBODIMENTS

Throughout this document, unless otherwise indicated to the contrary, the terms “comprising”, “consisting of”, “having” and the like, are to be construed as non-exhaustive, or in other words, as meaning “including, but not limited to.”

Furthermore, throughout the specification, unless the context requires otherwise, the word “include” or variations such as “includes” or “including” will be understood to imply the inclusion of a stated integer or group of integers but not the exclusion of any other integer or group of integers.

Unless defined otherwise, all technical and scientific terms used herein have the same meaning as is commonly understood by a skilled person to which the subject matter herein belongs.

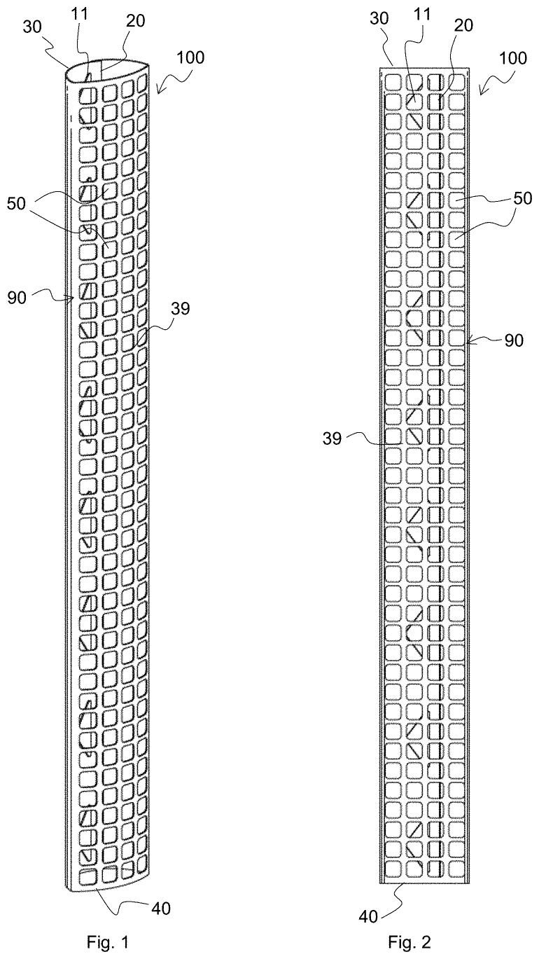

Exemplary embodiments of the support 100 for a climbing plant 200 will be described below with reference to FIGS. 1 to 12, wherein the same reference numerals are used to refer to the same or similar parts.

In an exemplary embodiment of the support 100 for a climbing plant, the support 100 comprises a tubular structure 100 defining a volume for containing therein a substrate (not shown), as shown in FIGS. 1 to 7. The tubular structure 100 has a plurality of root-passage holes 50 through which roots of the climbing plant 200 may engage the substrate placed in the support 100. In use, the substrate should be kept moist. Besides allowing passage of roots into the substrate for water uptake by the plant 200, the root-passage holes 50 also promote slow and continuous release of moisture from the moist substrate into the atmosphere that provides humidity to encourage proper formation and unfurling of leaves of the plant 200, without requiring energy input unlike other humidification methods such as ultrasonic humidification. The root-passage holes 50 also prevent water logging in the substrate, allowing the substrate to provide moisture and nutrients for plant growth while avoiding root rot due to the roots remaining in overly wet conditions.

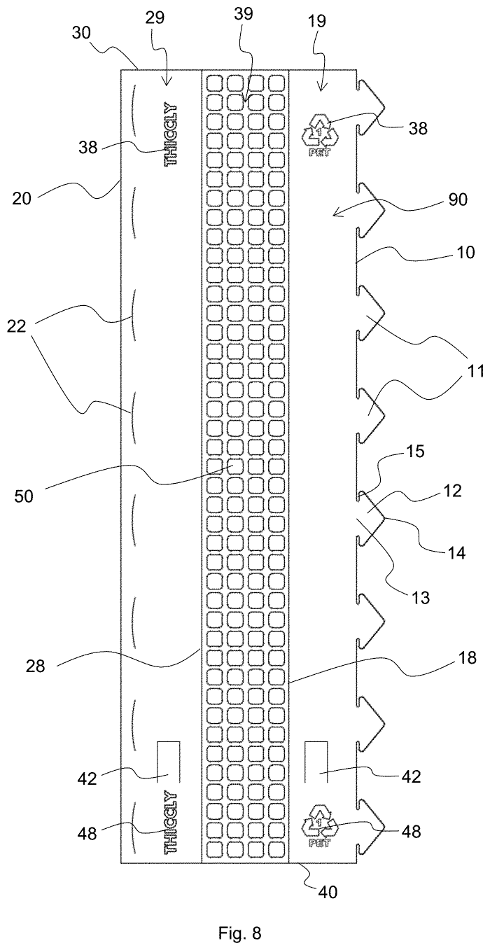

The support 100 is assembled from a blank 90 comprising a single sheet 90 of plastic material having a first long edge 10, a first short edge 40, a second long edge 20, and a second short edge 30, as shown in FIGS. 8-10. Before assembly, the sheet 90 is preferably flat so as to allow flat shipping to minimize transport logistics carbon footprint. Further preferably, the single sheet 90 of plastic material comprises polyethylene terephthalate (PET) that is readily recyclable, so as to be ecologically friendly, although other suitable plastics such as polypropylene (PP) may also be used. PET or PP are also advantageously transparent which allows the support 100 to be visually unobtrusive during use and to provide a view into the growing conditions of the plant roots. Viewing root growth conditions can aid in troubleshooting plant growing conditions, such as early identification and intervention to growth of harmful microbes.

The plurality of root-passage holes 50 are provided through the sheet 90 of plastic material. In the exemplary embodiment, the root-passage holes 50 each have a shape of a square with rounded corners. In other embodiments (not shown), the root-passage holes 50 may have other shapes such as triangles, circles, rectangles, or hexagons, for example, or any other shape or combination of different shapes. Each root-passage hole 50 is sized to allow roots of the plant 200 to pass easily through the root-passage hole 50 while preventing substrate (not shown) that is contained in the support 100 from falling out of the root-passage holes 50. For example, each root-passage hole 50 may have a dimension (e.g., its diameter or a length of a side of the root-passage hole 50, depending on its shape) ranging from about 5 mm to about 25 mm, preferably around 12 mm. The root-passage holes 50 can have any variation of shapes.

The sheet 90 is provided with an integral plurality of tabs 11 projecting from the first long edge 10. By integral, it is meant that the plurality of tabs 11 are integral with and part of the sheet 90, and not separate parts that are attached to the sheet 90 by some means. The integral plurality of tabs 11 are spaced apart from each other at intervals along the first long edge 10. The sheet 90 is also provided with a corresponding plurality of tab-engagement holes 22 provided adjacent the second long edge 20. The tab-engagement holes 22 are spaced apart from each other at intervals along the second long edge 20. The spacing at intervals of the plurality of tabs 11 and the plurality of tab-engagement holes 22 along the first and second long edges 10, 20 respectively should be the same, in order to allow the plurality of tabs 11 to be passed through the corresponding plurality of tab-engagement holes 22 in order to assemble the sheet 90 into a tubular structure 80.

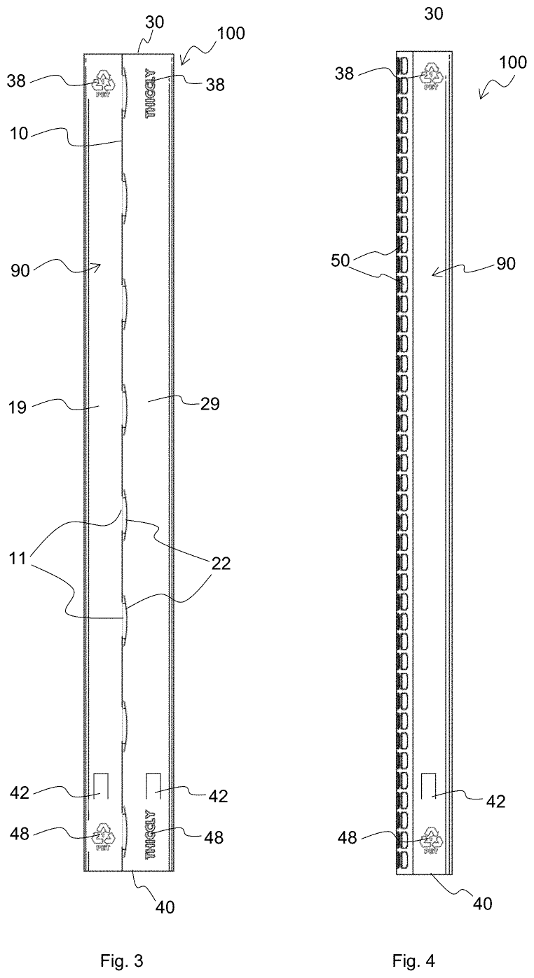

In the exemplary embodiment, as can be seen particularly in FIGS. 8-10 showing the blank 90, the plurality of tabs 11 each comprises a tab head 12 and a tab neck 13 that connects the tab head 12 to the first long edge 10. In the same exemplary embodiment, the plurality of tab-engagement holes 22 each comprises a slit 22 provided through the sheet 90. Each slit 22 is configured to allow the tab head 12 to be manipulated through the slit 22, while preventing slipping of the tab head 12 back out of the slit 22, as can be seen particularly in FIGS. 3, 5 and 6. In this way, after the tab heads 12 of the plurality of tabs 11 have been passed through the plurality of tab-engagement holes 22, the plurality of tabs 11 engage the plurality of tab-engagement holes 22 such that the sheet 90 is assembled into the tubular structure 100 that will not come apart during use. The assembled tubular structure 100 has open ends each defined by one of the short edges 30, 40. Preferably, as can be seen in FIGS. 8-10, a free end 14 of the tab head 12 is smaller in width than the length of each slit 22 so as to facilitate passing the tab head 12 through the slit 22. Further preferably, a necked end 15 of the tab head 12 that adjoins the tab neck 13 has a width that is greater than the length of the slit 22, to prevent the tab head 12 from slipping back out of the slit 22 after assembly. Appreciably, the tab neck 13 should have a width that is able to be accommodated by the length of the slit 22 and a widest part of the tab head 12 is greater in length than the length of the slit 22. Each of the plurality of slits 22 is preferably curved, in a direction to allow easy entry of tab head 12, during assembly, but inhibit accidental removal. For example, the curvature of each slit 22 may be convex towards the second long edge 20 as can be seen in FIGS. 8-10. In alternative embodiments, each of the plurality of slits 22 may be straight or feature a reverse curve to allow easy disassembly in other variants based on various use cases and purpose.

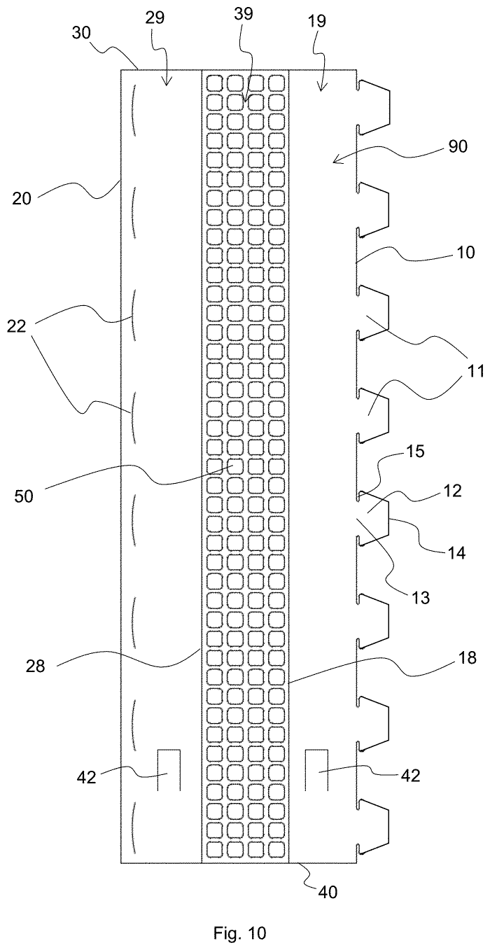

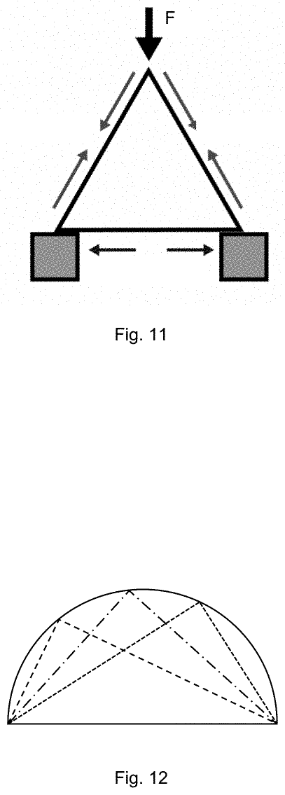

In FIGS. 1, 2, and 6-8 of the exemplary embodiment, it can be seen that the tab heads 12 have a triangular shape pointing away from the first long edge 10. In a first alternative embodiment as shown in FIG. 10, the tab head 12 may comprise a semi-circle 12 where a diameter of the semi-circle forms the necked end 15 of the tab head 12. In a second alternative embodiment as shown in FIG. 11, the tab head 12 may comprise an isosceles trapezoid 12 wherein a shorter of its parallel sides forms the free end 14 of the tab head 12 and a longer of its parallel sides forms the necked end 15 of the tab head 12.

In a further exemplary embodiment (not shown), the tab head 12 may have a trapezoidal or rectangular shape while the plurality of tab-engagement holes 22 may each comprise a circular hole having a diameter that is less than a vertical length of the trapezoidal or rectangular shape when the support 100 is in the upright position. To assemble the support 100, the tab head 12 may be temporarily and elastically rolled up into at least a partial cylinder having a diameter less than that of the tab-engagement hole 22, inserted through the tab-engagement hole 22, and then released from the rolled-up configuration. Upon release, the tab head 12 resumes its usual trapezoidal or rectangular shape so that it cannot slip back out of the tab-engagement hole 22.

In an exemplary embodiment of use, as shown in FIG. 7, the support 100 may be placed upright with a bottom end 40 of the support 100 embedded in a growing medium 310 provided in a plant pot 300 (as shown in FIG. 7) and a top end of the support 100 open to receive water for continual watering of the substrate that has been placed in the assembled support 100. In alternative embodiments of use (not shown), the support 100 may be placed upright with a bottom end of the support 100 embedded in growing medium provided in a planter or garden bed or any other desired location where the climbing plant is intended to be grown.

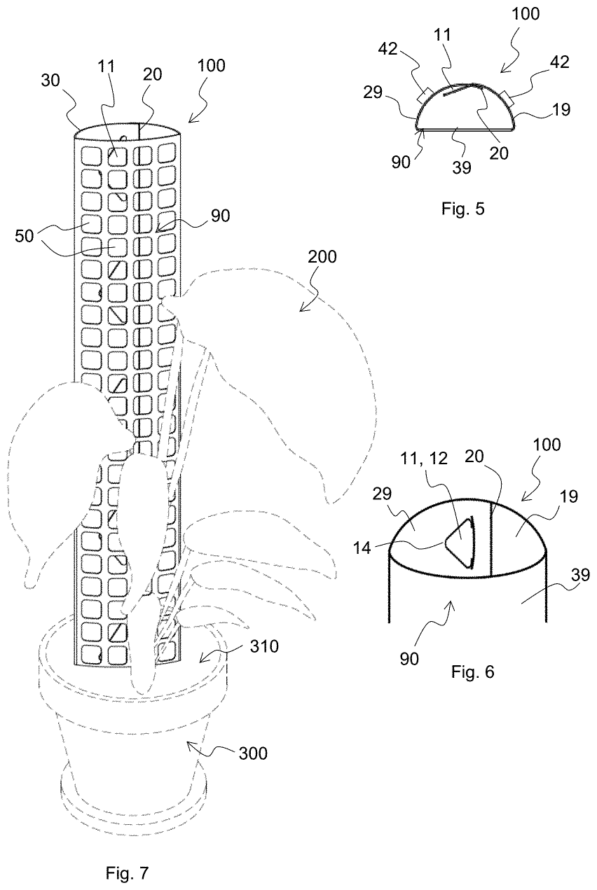

To improve anchorage of the support 100 in the growing medium, the support 100 may comprise one or more anchor tabs 42, as can be seen in FIGS. 3-5 and 8-10. Each anchor tab 42 is integral with the blank 90 and may comprise a U-shaped cut 42 made in the sheet 90 adjacent the first short edge 40 of the sheet 90. The U-shaped cut 42 should be oriented such that the two legs of the U-shaped cut 42 point towards the first short edge 40 (as can be seen in FIGS. 3-4 and 8-10). Before use, each anchor tab 42 is assembled by bending it away from the main body of the sheet 90, as can be seen in FIG. 5. In use, the pushed-out anchor tab 42 is located within the growing medium and opens upwardly and extends outwardly from a generally vertical surface of the support 100 when the support 100 has been properly embedded in the growing medium. In this way, each anchor tab 42 acts as a barb against the growing medium 310 to reduce the ease with which the support 100 can be pulled upwardly out of the growing medium.

In the exemplary embodiment as shown in FIGS. 1, 2, 4, 7 and 9, the sheet 90 may comprise a first longitudinal portion 19 comprising the first long edge 10, a second longitudinal portion 29 comprising the second long edge 20, and a central longitudinal portion 59 provided between the first and second longitudinal portions 19, 29. The plurality of root-passage holes 50 are provided through the central longitudinal portion 39, and may also be provided through the first and second longitudinal portions 19, 29 (not shown).

Where the sheet 90 comprises the first, second and central longitudinal portions 19, 29, 39, the sheet 90 may include a first longitudinal score line 18 provided on the sheet to facilitate bending without breaking of the sheet 90 between the first longitudinal portion 19 and the central longitudinal portion 39. The sheet 90 may also include a second longitudinal score line 28 provided to facilitate bending without breaking of the sheet 90 between the second longitudinal portion 29 and the central longitudinal portion 39. In this way, the sheet 90 may be easily bent along both the first and second longitudinal score lines 18, 28 in order to bring the plurality of tabs 11 into engagement with the plurality of tab-engagement holes 22 during assembly of the sheet 90 into the tubular structure 100. When the plurality of tabs 11 are in engagement with the plurality of tab-engagement holes 22, the sheet 90 is assembled into a tubular structure 100 having a generally semi-circular cross-section as can be seen in FIGS. 1 and 5-7.

A semi-circular cross-section for the support 100 is advantageous in resisting lateral forces that may be applied to the support 100, as explained below. As can be seen in FIG. 11, when a force F is applied to a corner of a triangle that is resting on a side that is opposite the corner where the force F is applied, the force F is distributed down the other two sides of the triangle that are adjacent the corner where the force F is applied. This puts those two sides of the triangle in compression (as indicated by the collinear arrows pointing towards each other). At the same time, this puts the side of the triangle that is opposite the corner where the force F is applied in tension, as indicated by the collinear arrows pointing away from each other. This makes a triangle the most rigid polygon among all polygonal shapes. By the same reasoning, as the semi-circular cross-section of the support 100 effectively provides continuously variable triangles of support as illustrated in FIG. 12, this gives the support 100 maximal strength to resist lateral forces that may be experienced by the support 100. Such lateral forces may include the weight of the plant 200, wind blowing on the plant 200 and the support 100, accidental forceful contact with the plant 200 or the support 100, for example.

In alternative embodiments (not shown), no score lines may be provided on the sheet 90 of plastic material such that when the plurality of tabs 11 are in engagement with the plurality of tab-engagement holes 22, the assembled support 100 has a tubular structure 100 having a generally circular cross-section.

In the exemplary embodiment as shown in FIGS. 1, 2, 4, 7 and 9, the plurality of root-passage holes 50 are arranged in a grid configuration through the sheet 90. In alternative embodiments, the placement of the root-passage holes 50 through the sheet 90 may be arranged in other patterns and designs through the sheet 90, as may be aesthetically desired.

As the blank 90 from which the support 100 is assembled is mass produced, it will be appreciated the plurality of tabs 11 and tab-engagement holes 22 are factory pre-aligned. As a result of this alignment-free design, when the support 100 is being assembled from the blank 90, no stresses are induced in trying to align any parts of the support 100. In this way, no residual stresses exist in the assembled support 100, thereby preventing buckling stress-induced structural failure during use of the support 100.

It should be appreciated that the support 100 can be readily extended in length in order to continue supporting the climbing plant 200 as it grows beyond the length of one support 100, without having to remove the plant 200 from the support in order to attach the plant 200 to a taller support. This may be achieved by joining multiple units of the support 100 together, i.e., by inserting a bottom end of an upper unit of the support 100 into a top end of a lower unit of the support 100, so that the resulting extended support 100 has a total length that is close to a multiple of the length of one unit of the support 100, the multiple being proportionate to the number of units of the support 100 used in combination.

To prevent two units of the support 100 from coming apart when joined together to form the extended support, each support 100 may be provided with a first interlocking structure 48 located adjacent the first short edge 40 (i.e., lower end) of the support 100 and a second interlocking structure 38 located adjacent the second short edge 30 (i.e., upper end) of the support 100. The first and second interlocking structures 48, 38 are longitudinally aligned in parallel with the first long edge 10 of the sheet 90. When two units of the support 100 are joined to create the extended support of increased length, the first interlocking structure 48 of the upper unit of the support 100 engages the second interlocking structure 38 of the lower unit of the support 100 to prevent separation of the first unit of the support from the second unit of the support.

For example, the first and second interlocking structures 48, 38 may each comprise at least one embossing made in the sheet 90, as shown in FIGS. 3, 4 and 8. Each embossing 48, 38 may comprise text, a logo, a symbol or any other desired shape. When the upper and lower units of the support 100 are joined together, the embossings 48, 38 stack with each other, thereby engaging each other, wherein the stacking creates a frictional force to reduce the ease with which the two units of the support 100 may come apart.

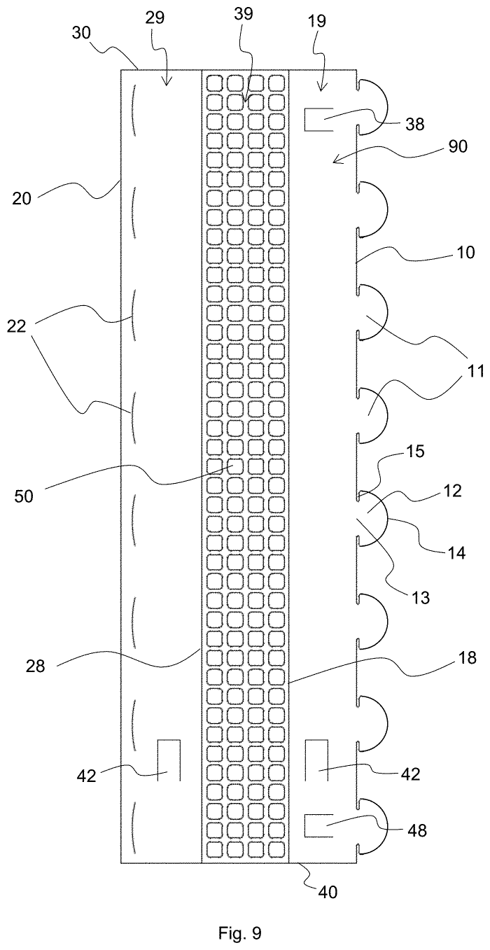

In another example as shown in FIG. 9, the first and second interlocking structures 38, 48 may each comprise each comprise a protruding flap 38, 48 assembled from a U-shaped cut 38, 48 made in the sheet 90 wherein legs of the U-shaped cut 38, 48 point towards either the first long edge 10 or the second long edge of the sheet 99. In use, when the upper and lower units of the support 100 are joined together, the first and second U-shaped cuts 38, 48 are congruent with each other. This allows the flaps 38, 48 to be bent in a same direction away from a surface of the extended support 100. In this way, the flaps 38, 48 engage each other and also the main bodies of the first and second units of the supports, thereby locking the two units of the support 100 together to prevent them from easily coming apart.

As can be appreciated from the above description, because the tubular structure 100 of the support 100 is assembled from a single sheet of plastic material 90, the tubular structure 100 comprises a continuously reinforced, pressure-stabilised semi-monocoque structure having no joints between parts of different materials (such as those found in the prior art supports that comprise a plastic longitudinal section of a cylinder assembled with a wire mesh via zip ties). Consequently, the presently disclosed support 100 is extremely strong and lightweight with improved strength-to-weight ratio over existing supports, especially when filled with a substrate that has expanded as a result of water absorption by the substrate, and also when experiencing pressure exerted by the roots of the climbing plant 200. In fact, use of slightly expanding substrates in the support 100, such as dried sphagnum moss or coconut chips that expand a little when wetted, helps to pressure-stabilize the support 100 further from vertical and lateral stresses. The present support 100 and in particular the exemplary embodiment having a semi-circular cross-section thus provides maximal vertical rigidity against lateral forces to support the climbing plant 200 thereon, while allowing roots of the climbing plant 200 to anchor themselves into different parts of the substrate contained in the support 100 as the plant 200 grows upwards. By being made of a single sheet 90 of recyclable material, the support 200 is advantageously ecologically friendly compared to existing supports made of wire mesh with or without other materials, and also reduces shipping-induced carbon emissions as it can be flat-packed to greatly increase packing density. The support 200 is also easy to assemble as the plurality of tabs 11 and tab-engagement holes 22 in the blank 90 are already factory pre-aligned so that they match up readily during assembly, thereby avoiding residual stresses that can arise due to forcing parts into alignment during assembly of prior art supports.

While there has been described in the foregoing description exemplary embodiments of the present invention, it will be understood by those skilled in the technology concerned that many variations in details of design, construction and/or operation may be made without departing from the present invention.

1. A support for a climbing plant, the support comprising:
a tubular structure defining a volume for containing therein a substrate, the tubular structure having a plurality of root-passage holes for passage therethrough of roots of the climbing plant to engage the substrate, wherein the tubular structure comprises a single sheet of plastic material having a first long edge, a first short edge, a second long edge, and a second short edge;
the sheet having the plurality of root-passage holes provided therethrough;
the sheet having an integral plurality of tabs extending from the first long edge and spaced apart from each other at intervals along the first long edge;
the sheet having a corresponding plurality of tab-engagement holes provided adjacent the second long edge and spaced apart from each other at intervals along the second long edge,
wherein the plurality of tabs and the corresponding plurality of tab-engagement holes are in engagement with each other such that the sheet is assembled into the tubular structure.

2. The support of claim 1, wherein the sheet comprises a first longitudinal portion comprising the first long edge, a second longitudinal portion comprising the second long edge, and a central longitudinal portion provided between the first and second longitudinal portion, wherein the plurality of root-passage holes are provided on at least the central longitudinal portion.

3. The support of claim 2, wherein the sheet comprises a first longitudinal score line provided to facilitate bending without breaking of the sheet between the first longitudinal portion and the central longitudinal portion, wherein the sheet comprises a second longitudinal score line provided to facilitate bending without breaking of the sheet between the second longitudinal portion and the central longitudinal portion, and wherein bending of the sheet along both the first and second longitudinal score lines facilitates meeting and engagement of the plurality of tabs with the plurality of tab-engagement holes.

4. The support of claim 1, wherein each of the plurality of tabs comprises a tab head and a tab neck connecting the tab head to the first long edge, wherein the tab head is configured to be manipulated through a corresponding one of the plurality of tab-engagement holes and to prevent slipping of the tab head back out of the tab-engagement hole, and wherein the tab neck has a width able to be accommodated by the tab-engagement hole.

5. The support of claim 4, wherein each of the plurality of tab-engagement holes comprises a slit provided through the sheet, wherein each tab head has a free end and a necked end adjoining the tab neck, wherein the free end has a width less than the length of the slit, and wherein the necked end has a width greater than a length of the slit.

6. The support of claim 5, wherein the tab head has a shape that is one of: a triangle, a semi-circle, and an isosceles trapezoid.

7. The support of claim 1, wherein the plurality of root-passage holes are arranged in a grid configuration through the sheet.

8. The support of claim 1, wherein the plastic material comprises polyethylene terephthalate.

9. The support of claim 1, wherein multiple units of the support are joinable by insertion of a lower end of a first unit the support into an upper end of a second unit of the support to create an extended support of increased length.

10. The support of claim 9, wherein the support includes a first interlocking structure located adjacent the lower end of the support and a second interlocking structure located adjacent the upper end of the support, wherein the first and second interlocking structures are longitudinally aligned in parallel with the first long edge of the sheet, wherein when the first and second units of the support are joined to create the extended support of increased length, the first interlocking structure of the first unit of the support engages the second interlocking structure of the second unit of the support to prevent separation of the first unit of the support from the second unit of the support.

11. The support of claim 10, wherein the first and second interlocking structures each comprise an embossing made in the sheet.

12. The support of claim 10, wherein the first and second interlocking structures each comprise a flap defined by a U-shaped cut made in the sheet wherein legs of the U-shaped cut are parallel with the first and second short edges, wherein when the first and second units of the support are joined to create the extended support, the first U-shaped cut of the first unit of the support is congruent with the second U-shaped cut of the second unit, such that bending the flaps together in a same direction away from a surface of the extended support prevents separation of the first unit of the support from the second unit of the support.

13. The support of claim 1, further comprising at least one anchor tab provided adjacent the first short edge for engaging a growing medium in which the support is embedded to anchor the support in the growing medium, the anchor tab comprising an upward facing and outwardly extending tab assembled from a further U-shaped cut made in the sheet wherein legs of the further U-shaped cut point towards the first short edge.

14. A blank for forming a support for a climbing plant, the blank comprising:
a single sheet of plastic material having a first long edge, a first short edge, a second long edge, and a second short edge;
the sheet having a plurality of root-passage holes for passage therethrough of roots of the climbing plant;
the sheet having an integral plurality of tabs extending from the first long edge and spaced apart from each other at intervals along the first long edge;
the sheet having a corresponding plurality of tab-engagement holes provided adjacent the second long edge and spaced apart from each other at intervals along the second long edge,
wherein the plurality of tabs and the corresponding plurality of tab-engagement holes are configured to engage each other for assembling the sheet into a tubular structure to form the support.

15. The blank of claim 14, wherein the sheet comprises a first longitudinal portion comprising the first long edge, a second longitudinal portion comprising the second long edge, and a central longitudinal portion provided between the first and second longitudinal portion, wherein the plurality of root-passage holes are provided on at least the central longitudinal portion.

16. The blank of claim 15, wherein the sheet comprises a first longitudinal score line provided to facilitate bending without breaking of the sheet between the first longitudinal portion and the central longitudinal portion, wherein the sheet comprises a second longitudinal score line provided to facilitate bending without breaking of the sheet between the second longitudinal portion and the central longitudinal portion, and wherein bending of the sheet along both the first and second longitudinal score lines facilitates meeting of the plurality of tabs with the plurality of tab-engagement holes during assembly of the sheet into the support pole.

17. The blank of claim 14, wherein each of the plurality of tabs comprises a tab head and a tab neck connecting the tab head to the first long edge, wherein the tab head is configured to be manipulated through a corresponding one of the plurality of tab-engagement holes and to prevent slipping of the tab head back out of the tab-engagement hole, and wherein the tab neck has a width able to be accommodated by the tab-engagement hole.

18. The blank of claim 17, wherein each of the plurality of tab-engagement holes comprises a slit provided through the sheet, wherein each tab head has a free end and a necked end adjoining the tab neck, wherein the free end has a width less than the length of the slit, and wherein the necked end has a width greater than a length of the slit.

19. The blank of claim 18, wherein the tab head has a shape that is one of: a triangle, a semi-circle, and an isosceles trapezoid.

20. The blank of claim 14, wherein the plurality of root-passage holes are arranged in a grid configuration through the sheet.

21. The blank of claim 14, wherein the plastic material comprises polyethylene terephthalate.

22. The blank of claim 14, wherein the blank includes a first interlocking structure located adjacent the first short edge and a second interlocking structure located adjacent the second short edge, wherein the first and second interlocking structures are longitudinally aligned in parallel with the first long edge of the sheet, such that when a first unit of the blank and a second unit of the blank are each assembled to form a respective first unit of the support and second support unit of the support, and when the first and second units of the support are joined by insertion of a lower end of the first unit the support into an upper end of the second unit of the support to create an extended support of increased length, the first interlocking structure engages the second interlocking structure to prevent separation of the first unit of the support from the second unit of the support.

23. The blank of claim 22, wherein the first and second interlocking structures each comprise an embossing made in the sheet.

24. The blank of claim 22, wherein the first and second interlocking structures each comprise a flap defined by a U-shaped cut made in the sheet wherein legs of the U-shaped cut are parallel with the first and second short edges, when the first and second units of the support are joined to create the extended support, the first U-shaped cut of the first unit of the support is congruent with the second U-shaped cut of the second unit, such that bending the flaps together in a same direction away from a surface of the extended support prevents separation of the first unit of the support from the second unit of the support.

25. The blank of claim 14, wherein the blank includes an anchor tab defined by a further U-shaped cut made in the sheet adjacent the first short edge, wherein legs of the further U-shaped cut-out point towards the first short edge.
